(19) United States
(12) Patent Application Publication
(10) Pub. No.: US 2018/0315062 A1
(43) Pub. Date: Nov. 1, 2018

(54) SYSTEMS AND METHODS FOR AGGREGATING, ANALYZING, AND PRESENTING DATA FROM MULTIPLE APPLICATIONS

(71) Applicant: SalesWise, Inc., Atlanta, GA (US)

(72) Inventors: Jason Parekh, Atlanta, GA (US); Gregg Freishtat, Atlanta, GA (US); Matt Heindl, Atlanta, GA (US)

(21) Appl. No.: 15/963,642

(22) Filed: Apr. 26, 2018

Related U.S. Application Data
(60) Provisional application No. 62/490,285, filed on Apr. 26, 2017.

(51) Int. Cl. G06Q 30/02; G06Q 30/00; G06F 3/0482

(52) U.S. Cl. CPC G06Q 30/0201; G06F 3/0482; G06Q 30/01

(57) ABSTRACT

This disclosure relates to a system for aggregating, analyzing, and presenting data from multiple applications that are used by the stakeholders on either the seller side or the buyer side (e.g., the VP of Sales, the inside sales representative, etc.). In certain embodiments, systems and methods can facilitate the aggregation of application data from a variety of sources and/or application programs, such as Salesforce, Google, Office 365/Exchange, data enrichment services, WHOIS servers, and/or corporate websites. The system introduces functionality that conventional application data systems (e.g., CRM applications, calendar applications, etc.) do not. In particular, the specific rules facilitate determinations as to whether a sales relationship exists between the first business entity and the second business entity. Further, the specific rules facilitate the identification and removal of duplicative data that is typically found among, for example, the CRM data and the enterprise data.

### CROSS-REFERENCE TO RELATED APPLICATION

This application claims benefit of U.S. Provisional Application No. 62/490,285, filed Apr. 26, 2017, entitled “SYSTEMS AND METHODS FOR AGGREGATING, ANALYZING, AND PRESENTING DATA FROM MULTIPLE APPLICATIONS,” the contents of which are hereby incorporated by reference.

### TECHNICAL FIELD

This disclosure generally relates to systems and methods for aggregating, analyzing, and presenting data and, more particularly, to an insight application that is configured to generate client data associated with a first business entity based at least in part on aggregated application data and to cause graphical representations of a sales relationship between the first business entity and a second business entity to be displayed a client computing device.

### BACKGROUND

Conventional business operations, marketing, email, and calendars typically utilize respective applications to collect and organize separate business data for each of the respective applications. Using each of these respective applications, business workers spend countless hours trying to find useful information from the separate business data and/or analyzing the separate business data. Additionally, within each of the respective applications, business data for an application can be partitioned (or screened) based on, for example, user accounts, so only select business data is accessible by an individual user account. Typically, the separate business data from the respective applications is inaccessible across applications, thereby rendering it impossible, or otherwise extremely difficult and/or time consuming, for the business workers to find insights, for example, analytics or trends, among and within the respective applications. Further, the separate business data may include duplicative inputs that make finding such insights even more challenging. Consequently, lost worker productivity and inefficient data analytics can result in lost or unrealized business opportunities.

### BRIEF DESCRIPTION OF THE FIGURES

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 illustrates an example networked system environment according to at least one embodiment of the disclosure.

FIGS. 2-4 illustrate flow diagrams of example processes according to at least one embodiment of the disclosure.

FIG. 5 illustrates an exemplary client computing device according to at least one embodiment of the disclosure.

FIGS. 6-14 illustrate example graphical user interfaces (GUIs) according to at least one embodiment of the disclosure.

FIG. 15 illustrates an exemplary methodology according to at least one embodiment of the disclosure.

FIG. 16 illustrates an example architecture for an associated computer system according to at least one embodiment of the disclosure.

### DETAILED DESCRIPTION

### Overview

In a conventional sales environment, there can be multiple users, entities, and/or stakeholders on both the seller side and the buyer side. For example, on the seller side or a seller company (or a business entity), each of a business development representative, an inside sales representative, a sales engineer, a product manager, and/or a Vice-President (“VP”) of Sales may all be involved in a deal. On the buyer side or a buyer company, there are likely to be multiple users, entities, and/or stakeholders. Since electronic mailboxes, or email boxes, can be partitioned by a user for security reasons, it is typically not possible for one person to have a complete view of the business relationship between the seller side and the buyer side. This lack of visibility can introduce friction and/or difficulty for individuals on either the seller side or the buyer side. For example, a VP of Sales may be unable to accurately determine the likelihood of the deal closing, an inside sales representative does not have any visibility into the conversation that the business development representative had, or a sales engineer may require implementation-specific information that only the sales representative has.

Certain embodiments of the disclosure are directed to systems and methods for aggregating, analyzing, and presenting data from multiple applications that are used by the stakeholders on either the seller side or the buyer side (e.g., the VP of Sales, the inside sales representative, etc.). In certain embodiments, systems and methods can facilitate the aggregation of application data from a variety of sources and/or application programs, such as Salesforce, Google, Office 365/Exchange, data enrichment services, WHOIS servers, and/or corporate websites. The aggregated application data can be used to facilitate generation of a combined data set, for example, client data associated with a first business entity (e.g., the seller side or the buyer side). During the generation of the combined data set, the application data from the variety of sources and/or application programs can be parsed and filtered such that sales relationships between the first business entity and other business entities can be determined. In certain embodiments of the disclosure, systems and methods can facilitate analyzing the received or otherwise aggregated application data (or the client data associated with the first business entity). Further, in certain embodiments of the disclosure, one or more analyses based at least in part on the collected application data can be generated. In certain embodiments of the disclosure, some or all of the analyzed data and analyses can be presented in one or more user interfaces output to a computer, a client device, or other user devices.

In one embodiment, the systems and methods can: (1) connect to electronic mailboxes (or email boxes) of every stakeholder with the first entity and any number of other authenticated data sources, (2) synchronize the email mailboxes, (3) organize some or all of the data into a single company-wide database (e.g., the client data), (4) and apply access controls to grant and/or block permission to one or more other individual users based at least in part on any number of customer-defined policies.

In one embodiment, the systems and methods can combine different pieces of the application data and organize the application data automatically into the combined data set (or client data associated with the first business entity), where the combined data set is partitioned by companies that a customer (e.g., the first business entity) has relationships with. For example, the system can connect to electronic mailboxes, or email boxes, and can automatically determine which companies a single email may be relevant for or associated with. The system can determine this based at least in part on factors such as: (1) domain names and company names within the email; (2) names of people within the email and their corresponding companies determined from other data processing; (3) a time that the email was sent; or (4) a sender of the email and his or her signature at the bottom of the email. The system can perform similar detection of other pieces of data from other sources (e.g., applications) such as a calendar application program or database, a customer relationship management (CRM) application (e.g., Salesforce), task applications, etc. The system can determine and assign the relevant companies to the pieces of data.

By applying specific rules to determine which companies the single email may be relevant for, the system introduces functionality that conventional application data systems (e.g., CRM applications, calendar applications) do not. In particular and as will be described in greater detail below, the specific rules facilitate determinations as to whether a sales relationship exists between the first business entity and the second business entity based at least in part on, for example, CRM data and enterprise service data. The sales relationship can include communications between stakeholders of the first business entity and the second business entity, documents exchanged between the stakeholders, deals at various stages (e.g., diligence, closing, etc.) between the business entities, etc. The determinations can be further based at least in part on features of the email as well as statistical analyses of trends found in multiple emails. In non-limiting examples, based on the specific rules, a determination that the first business entity is undergoing negotiations regarding a particular deal, where the negotiations are undertaken by a first stakeholder of the first business entity and a second stakeholder of the second business entity. Further, the specific rules may facilitate a determination that other stakeholders, of either the first business entity or the second business entity, have previously communicated with each other in a non-related deal (e.g., by identifying a calendar event in the enterprise data).

Further, the specific rules facilitate the identification and removal of duplicative data that is typically found among, for example, the CRM data and the enterprise data. As will be described in greater detail below, the duplicative data can include, for example, copies of emails between two stakeholders (e.g., a reply email that contains a copy of an original email), emails that include information that indicate a same business entity, individual, etc. Such duplicative data can oftentimes reduce the performance of searches and/or analyses to identify, for example, trends in a combined data set (conventionally formed based at least in part of the CRM data and the enterprise data). Further, the duplicative data can prevent, or otherwise minimize, determinations that a sales relationship may be exist between the first business entity and the second business entity.

As a result, at least one technical solution of certain embodiments of the disclosure is that a system can generate groupings of data (e.g., sales relationships) per company or business entity, and the system can output various graphical user interface (GUI) presentations, for example, with automatically organized cards indicative of relationships a company may have with a customer. The various GUI presentations can include one or more representations of a sales relationship between the first business entity and the second business entity, where the representation displays analytics and/or trends of the sales relationship. As previously stated, such analyses are based at least in part on the combined data set (generated based at least in part on the specific rules) that enables the system to determine whether a sales relationship exists. Further, another technical solution of certain embodiments of the disclosure is that the combined data set can be used by the system to access and present granular details about the sales relationship by way of the GUI presentations. In any instance, certain technical solutions of embodiments of the disclosure can improve performance and processing speed of an insight application executing on, for example, a client computing device.

### Example Overall Methodology

In an example overall methodology, a computer-executable data sync engine of an insight application is configured to aggregate application data associated with a first business entity. The application data can include: (1) CRM data that is gathered by a CRM application provider (e.g., SalesForce CRM) that facilitates case, task, and/or account management, client monitoring, etc.; (2) enterprise service data that is gathered by an enterprise service provider (e.g., Google G Suite, Microsoft Office 365/Exchange, etc.) that provides productivity software, for example, an email service, a calendar service, etc.; and (3) enrichment data (e.g., from WHOIS servers, corporate websites, etc.) that can be polled (or queried) by the data sync engine to verify identities of, for example, domain names, employees, etc., of business entities. In non-limiting examples, the CRM data can include an indication of a business deal (e.g., merger, acquisition, etc.) that has occurred between the first business entity and a second business entity; the enterprise service data can include emails, contacts, or calendar events; and the enrichment data can include domain registration data of the first business entity or the second business entity.

The data sync engine can be configured to obtain or be granted access to the sources of application data by having administrative access and/or login access to multiple accounts. For example, instead of the data sync engine having access to email data from a particular user account of enterprise service provider associated with the first business entity, the data sync engine, after obtaining the administrative access, can have global access to email data for all user accounts of the first business entity. In another example, the data sync engine can be configured to obtain or be granted access to multiple accounts of the sources of the application data.

Based at least in part on the aggregated application data associated with the first business entity, at least one merger component of the data sync engine can be configured to generate and store client data, where the client data can be analyzed by the insight application to determine or identify analytics or trends between the first business entity and the second business entity (e.g., a deal negotiation between the first business entity and the second business entity that has been managed by contacts at the respective business entities). As will be described in greater detail below, the at least one merger component can be configured to apply filtering rules to the aggregated application data to, for example, determine that a contact (e.g., a user email address, stakeholder, etc.) or activity (e.g., meeting, negotiation, etc.) is associated with the first business entity or the second business entity. After such determination, the insight application can add an indication of the contact or the activity to the client data. Further, the at least one merger component can be configured to actively monitor and pull new application data from an application data source as the new application data is added to the application data source. As the at least one merger component aggregates the new application data, the at least one merger component is configured to determine whether information from the new application data is to be added or enhance the client data. The new application data can be stored in a client queue.

In an example operation of the at least one merger component, the at least one merger component can be configured to retrieve an email associated with the first business entity, where the email has been sent by a member (e.g., a stakeholder) of the first business entity. The at least one merger component can be configured to parse or identify indicators that the email has been sent by the user based at least in part on identifying features, for example, a username of a sender in a header of the email. The at least one merger component can be configured to parse or identify a recipient email address of the email, then determine a username of the recipient and a domain associated with the username. The at least one merger component can determine an identify of an individual associated with the username, where the username is from a second business entity. Further, the at least one merger component can determine an identity of the second business entity (e.g., company name). The at least one merger component can perform these determinations or verify these determinations based on data that is received from one or more enrichment sources (e.g., WHOIS servers, websites associated with the second business entity, etc.). Based at least in part on the determinations, the at least one merger component can indicate that a sales relationship exists between the first business entity and the second business entity. As will be described in greater detail below, the at least one merger component can apply similar rules to other types of files and/or documents received from the aggregated application data, including word files, calendar events, etc.

A server continuity component of the insight application can be configured to actively monitor new application data received from the CRM application and/or the one or more enterprise services sources. In particular, the server continuity component can for example, determine that a previously identified sales relationship has a new event or individual (e.g., identity of a person associated with a username) that is related to or associated with the sales relationship. The server continuity component can update the client data such that the client data includes the new event or individual associated with the sales relationship.

A presentation component of the insight application can further be configured to cause an output of GUI presentations at one or more client computing devices of the first business entity. For example, a GUI presentation can include automatically organized cards indicative of relationships a company (e.g., a first business entity) may have with a customer (e.g., a first business entity). Further, access to the GUI presentations can be regulated by an access control component of insight application. In particular, the access control component can regulate a stakeholder's access to subsets of the client data and the GUI presentations generated based on the client data. For example, an executive of the first business entity could have access to all the client data and GUI presentations, while lower level associates of the first business entity could be limited to client data (and GUI presentations) associated with particular sales relationships, other business entities, etc. Access of the lower level associates could be further limited by, for example, temporal or geographical limitations.

Embodiments of the disclosure now will be described more fully hereinafter with reference to the accompanying figures, in which certain embodiments are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

### Example System Architecture

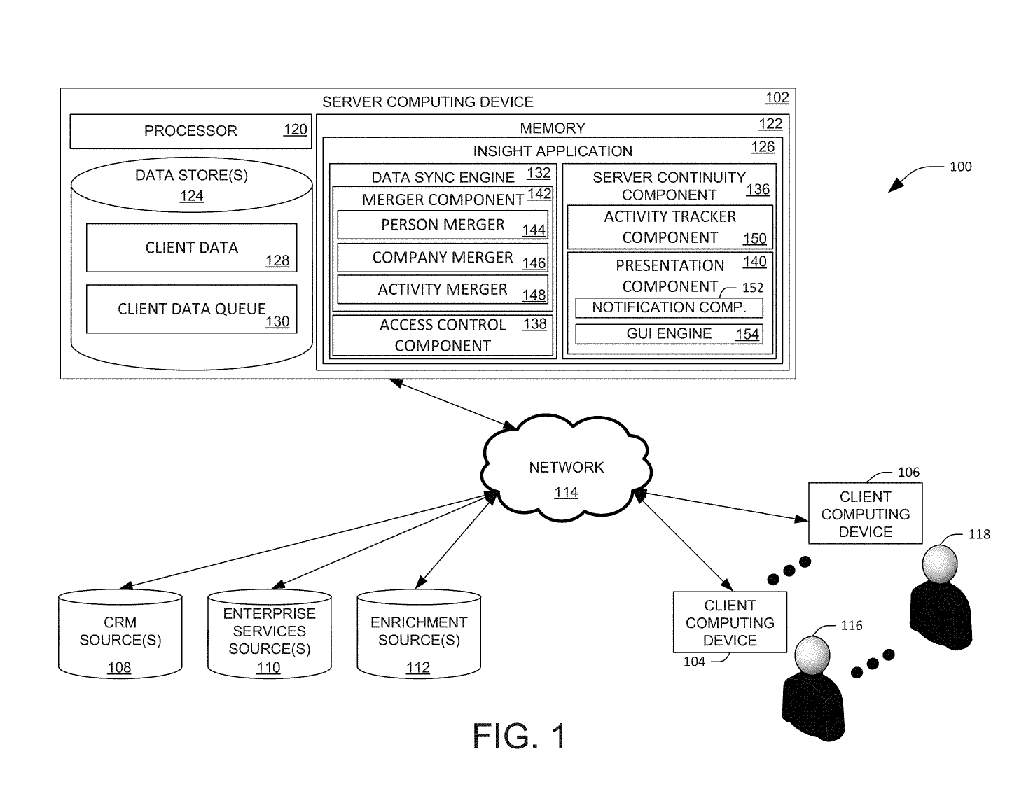

FIG. 1 illustrates an example networked system environment 100 according to at least one embodiment of the disclosure. As shown in FIG. 1, the system 100 may include a server computing device 102, one or more client computing devices 104-106, one or more CRM sources 108, one or more enterprise services sources 110, and one or more enrichment sources 112. Each of the computing devices 102-106 and sources 108-112 can be configured to communicate with one or more suitable networks 114, for example, the Internet, intranet, etc. Further, the system 100 can include one or more end users 116-118 that operate the one or more client computing devices 104-106. The one or more end users 116-118 may be utilizing the client computing devices 104-106 in connection with analyzing analytics and/or trends of a first business entity (that the one or more end users 116-118 are part of). In particular, the trends of the first business entity can be based on sales relationships that the first business entity has with other business entities.

With continued reference to FIG. 1, the computing devices 102-106 and/or sources 108-112 may obtain and store information associated with an application program executing on the computer, client, and/or server. For example, application program data from an email application and from a calendar/contact information application may be stored by the computing devices 102-106 and/or sources 108-112 in one or more associated databases or data stores. The database and/or data store may contain data files. As desired, application program data and associated information may be obtained from a wide variety of suitable sources, such as the computing devices 102-106 and/or sources 108-112, and/or databases or data stores and any number of data files can be obtained, collected, received, or retrieved. Additionally, as desired, the computing devices 102-106 and/or sources 108-112, and/or databases or data stores can provide information specific to a particular request based at least in part on one or more indicated preferences.

In particular, the one or more CRM sources 108 can include a CRM application provider (e.g., SalesForce CRM) that facilitates case/task management, client monitoring, etc. for the first business entity. The CRM provider may, for example, provide the above features by way of a CRM application that is executed on the client computing device, where the CRM application retrieves CRM data from the one or more CRM sources 108. In a non-limiting example, the CRM data can include an indication of a business deal (e.g., merger, acquisition, etc.) that the first business entity is undergoing as well as indications of whether aliases (e.g., usernames) associated with the one or more end users 116-118 are part of the business deal. The one or more enterprise services sources 110 can include an enterprise service provider (e.g., Google G Suite, Microsoft Office 365/Exchange, etc.) that provides productivity software, for example, an email service, a calendar service, etc. for the first business entity. For example, the enterprise service provider can provide email services to each of the one or more end users 116-118, where the enterprise service provider stores email as enterprise service data that can be configured to only be accessible to certain aliases (e.g., typically a user is only able to access email tied to their alias). The enterprise service data can further include calendar events, spreadsheets, etc.

Further, the one or more enrichment sources 112 can include data sources that can be polled (or queried) for enrichment data that can be used to verify identities related to, for example, domain names, identities of individuals of the first business entity (or other business entities), etc. For example, the one or more enrichment sources 112 can include WHOIS servers, corporate websites, etc.

With continued reference to FIG. 1, any number of the sources 108-112 and/or databases or data stores may be provided. The sources 108-112 may include any number of processors. Such devices may include and/or incorporate a server computer, a personal computer, one or more networked computing devices, an application-specific circuit, a minicomputer, a microcontroller, and/or any other processor-based device and/or combination of devices.

With continued reference to FIG. 1, each of the sources 108-112 may include one or more memory devices (generally referred to as memory), one or more input/output (“I/O”) interface(s), and/or one or more communication connections. The communication connections may interface with a database and/or data store, which may contain one or more data files, such as which may include application program data. For example, the data files may include information associated with one or more client devices, information associated with one or more application programs, rules and/or parameters, etc.

The memory may be any computer-readable medium, coupled to the one or more processors, such as random access memory (“RAM”), read-only memory (“ROM”), and/or removable storage devices. The memory may store one or more program modules utilized by the computer, such as an operating system (OS).

Certain embodiments may be provided as a computer program product including a non-transitory machine-readable storage medium having stored thereon instructions (in compressed or uncompressed form) that may be used to program a computer (or other electronic device) to perform processes or methods described herein. For example, certain embodiments may be provided as a computer program product or group of products that may be executed by the computers, client devices, servers, or other suitable computing systems. The machine-readable storage medium may include, but is not limited to, hard drives, floppy diskettes, optical disks, CD-ROMs, DVDs, read-only memories (“ROMs”), random access memories (“RAMs”), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not include, but are not limited to, signals that a computer system or machine hosting or running a computer program can be configured to access, including signals downloaded through the Internet or other networks. For example, distribution of software may be Internet download.

With reference to the contents of the memory, the data files may include any suitable data that facilitates the operation of the computer and/or interaction of the computer with one or more other components of the system.

The OS may be any suitable module that facilitates the general operation of the computer, as well as the execution of other application program modules.

The client computing devices 104-106 may be any suitable type of client computing device, including a desktop computing device, a laptop computing device, a mobile telephone, a tablet computing device, a wearable computing device, or the like. The client computing devices 104-106 may include one or more processors. The one or more processors may be implemented as appropriate in hardware, software, firmware, or combinations thereof. Software or firmware implementations of the one or more processors may include computer-readable or machine-readable instructions written in any suitable programming language to perform the various functions described. The client device, in addition to having one or more processors, may further include one or more memory devices (generally referred to as memory), one or more input/output (“I/O”) interface(s), and/or one or more communication connections. The communications connections may interface with the network 114 to transmit information.

Similar to memory above, the memory may be any computer-readable medium, coupled to the one or more processors of the merchant device, such as random access memory (“RAM”), read-only memory (“ROM”), and/or removable storage devices. The memory may store one or more program modules utilized by the client device, such as an operating system (OS).

The one or more I/O interfaces may facilitate communication between the computer and one or more input/output devices. For example, one or more user interface devices can include, but are not limited to, a display, a keypad, a keyboard, a touch screen display, a microphone, a speaker, a mouse, or any other similar device that can facilitate user interaction. The one or more network and/or communication connections may facilitate connection of the computer to any number of suitable networks , for example, the one or more network(s) illustrated in FIG. 1. In this regard, the computer may receive and/or communicate information to other components of the system.

With continued reference to FIG. 1, any number the client computing devices 104-106 may be included in the system. A client device may be configured to access one or more application programs hosted by the computers in order to review and/or manipulate information. In certain embodiments, a client device may include similar components as those discussed above for the computer. For example, a client device may include any number of processors, memories, I/O interfaces, and/or network communication interfaces.

A wide variety of suitable networks (which may be the same or separate networks 114) and/or communication channels may be utilized to facilitate communications among and between the server computing device 102, the one or more client computing devices 104-106, the one or more CRM sources 108, the one or more enterprise services sources 110, and the one or more enrichment sources 112. These networks may include, but are not limited to, one or more telecommunication networks, cellular networks, wide area networks (e.g., the Internet), and/or local area networks. Various methodologies as described herein may be practiced in the context of distributed computing environments. It will also be appreciated that the various networks may include one or more of networks, each with devices such as gateways and routers for providing connectivity between or among networks. Additionally, instead of, or in addition to, a network, dedicated communication links may be used to connect various devices in accordance with an example embodiment.

With continued reference to FIG. 1, the server computing device 102 includes a processor 120 and memory 122. The memory 122 stores instructions that are executed by the processor 120. The server computing device 102 further includes one or more data stores 124. The memory 122 includes an insight application 126. The one or more data stores 124 include client data 128 and a client data queue 130.

A data sync engine 132 of the insight application 126 is configured aggregate data related to the first business entity from the one or more CRM sources 108 and the enterprise services sources 110. As will be described in greater detail below, based on the aggregated data, the insight application 126 is configured to generate the client data 128 that includes indications of sales relationships between the first business entity and other business entities. The data sync engine 132 can use the client data queue 130 as a buffer or cache for the generation of the client data 128.

The insight application 126 further includes a server continuity component 134 that is configured to actively monitor new application data received/retrieved from the one or more CRM sources 108 and the enterprise services sources 110. In particular, the server continuity component 134 can for example, determine that a previously identified sales relationship has a new event or individual (e.g., identity of a person associated with a username) that is related to or associated with the sales relationship. The server continuity component 134 can update the client data 128 such that the client data 128 includes an indication of the new event or individual associated with the sales relationship.

The insight application 126 further includes an access control component 138 and a presentation component 140. The access control component 138 is generally configured to govern which business entities the insight application 126 can gather data about. For example, the access control component 138 can implement a blacklist such that the insight application 126 is prevented from monitoring activity of the first business entity with respect to business entities listed in a list (e.g., a blacklist). Further, the access control component 138 regulates access of the end users 116-118 to subsets of the client data 128 and the GUI presentations generated based on the client data 128 at, for example, the client computing devices 104-106. For example, a first account (e.g., profile for the insight application 126) for an executive of the first business entity could have access to all the client data 128 and GUI presentations, while a second account for lower level associates of the first business entity could be limited to client data 128 (and GUI presentations) associated with particular sales relationships, other business entities, etc. Access of the lower level associates could be further limited by, for example, temporal or geographical limitations. Access of the first account and the second account can be implemented by profile management techniques that are available in the art.

The presentation component 140 of the insight application is configured to retrieve client data 128 and cause an output of GUI presentations at the one or more client computing devices 104-106 for presentation to the end users 116-118. For example, a GUI presentation can include automatically organized cards indicative of relationships a company (e.g., a first business entity) may have with a customer (e.g., a first business entity). Additionally, as will be described in greater detail below the GUI presentations can include: a message activity pane or an activity frequency pane which are described in greater detail below.

### Illustrative Processes

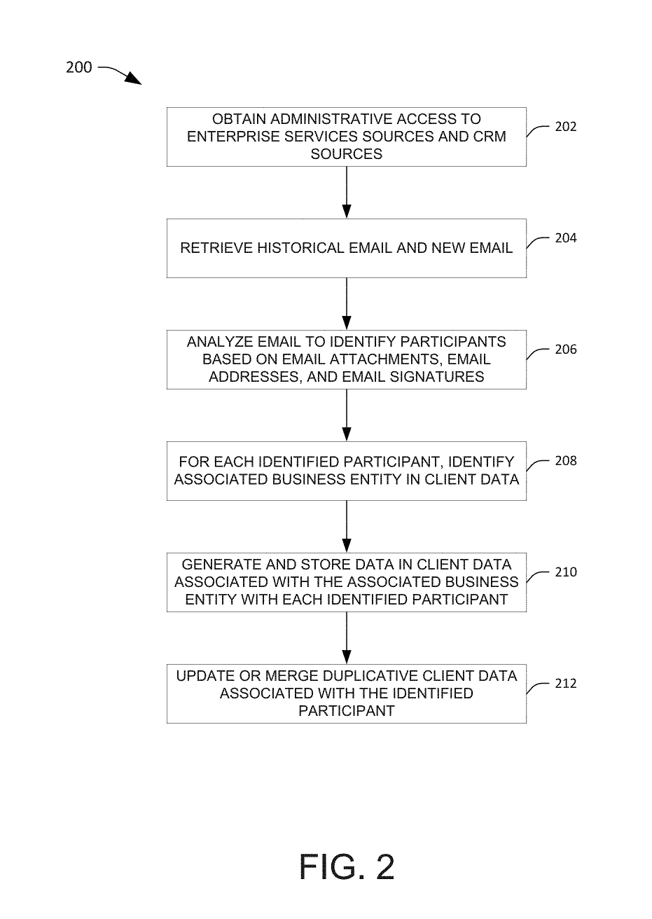

FIGS. 2-4 illustrates a flow diagram of example processes according to certain embodiments of the disclosure. In certain embodiments, certain operations, such as some or all of those illustrated in the process flows of FIGS. 2-4, may be performed by the system shown in FIG.

With more detail regarding the data sync engine 132, the data sync engine can include a merger component 142 that is configured to merge aggregated data from the one or more CRM sources 108 and the one or more enterprise services sources 110. With more particularity, the merger component 142 can include a person merger 144, a company merger 146, and an activity merger 148.

FIG. 2. illustrates an example embodiment of the per-user email synchronization process 200 that can occur, and how it is combined with other users' data to provide a single unified data set (or client data). At block 202, the person merger 144 can be configured to possess administrative access and/or login access to retrieve emails for stakeholders associated with a first business entity, where the emails are provided by, for example, an email application of the one or more enterprise service sources 110. At block 204, the person merger 144 can retrieve historical emails and new emails associated with each stakeholder of the first business entity to generate the client data 128. Further the person merger 144 can be configured to retrieve contacts information from the one or more CRM sources 110 that is indicative of individuals (e.g., stakeholders) of accounts that the first business entity is associated with (the person merger 144 may additionally be configured to have administrative access to the one or more CRM sources 110). The new emails can be stored in the client data queue 130 such that the historical emails are analyzed by the person merger 144 prior to the new emails.

At block 206, the person merger 144 can analyze each email in the historical emails and the new emails to identify participants from the first business entity and other participants from other business entities. More particularly, the person merger 144 is configured to identify email addresses in a header portion of each email and extract signature lines in the each email. Further, the person merger 144 is configured to extract attachments from the each email (e.g. a sales agreement, a term sheet, a calendar invitation, or an electronic profile), and then identify email addresses or signature lines in the extracted attachments. For example, the person merger 144 can use the header portion of the email to determine a first name, a last name, a business entity domain (e.g., website address), etc. Further, the person merger 144 can be configured compare and determine the header portion of the email to the signature line to, for example, confirm information from the header portion, complete missing information from the header portion (e.g., a business entity name, an informal name, a job title, a phone number, a postal address, etc.), etc.

At block 208, the person merger 144 is configured to identify an associated business entity in the client data 128 with the identified participant based on determined business entity domain or, if available, the business entity name. For example, if the domain name in the header of the email (e.g., a username associated with the participant) matches domain name in the client data, 128, the person merger 144 can determine that the participant is associated with the associated business entity.

At block 210, the person merger 144 is configured to generate and store in the client data 128 data indicative of each identified participant with the identified business entity. For each identified participant, the person merger 144 identifies an indication of the identified participant in the client data 128 (e.g., a match of the first name and the last name). The person merger 144 can be configured to generate an indication that the identified participant is a stakeholder of the identified associated business entity. Further, an indication that the identified participant has communicated with the first business entity can be generated, where the indication additionally indicates which participant of the first business entity received an email from the identified participant. The person merger 144 can also be configured to associate the email from which the identified participant is identified with, in the client data 128, corresponding to stakeholders and/or companies of the identified associated business entity.

At block 212, the person merger 144 is configured update or merge duplicative client data associated with the identified participant and/or the identified associated business entity. More particularly, the person merger can be configured to score values regarding information about the identified associated business entity (e.g., domain name, address, business entity) and determine if any newly identified information should be indicated as primary information. More particularly, the person merger 144 can be configured to track how often the associated business name has used a certain business entity name within a certain recent temporal period (e.g., last 90 days). If the certain business entity name has occurred a predetermined amount of time, the person merger 144 can determine that the certain business entity name is the primary business name of the associated business entity (e.g., to reflect a corporate name change of the associated business entity). Similarly, the person merger 144 can apply similar specific rules to data associated with the identified participant (e.g., informal name, job title, etc.), so that the client data 128 is updated with recent information regarding the identified participant (e.g., to reflect a change in title or last name of the identified participant).

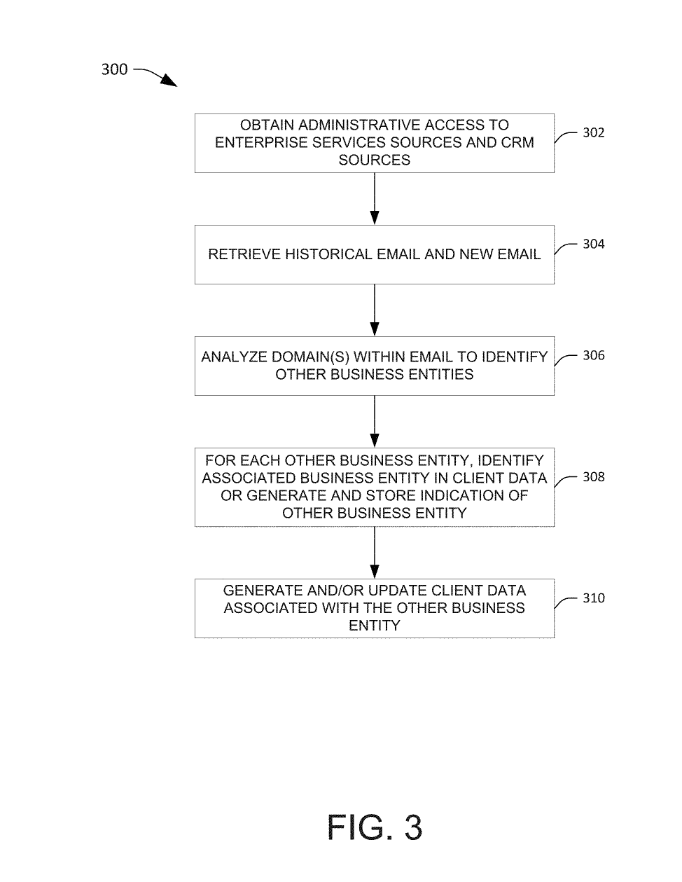

FIG. 3 illustrates an example embodiment of the per-company synchronization process 300 that can occur, and how it is combined with other users' data to provide a single unified data set (or client data).

At block 302, the company merger 146 can be configured to possess administrative access and/or login access to retrieve emails for stakeholders associated with a first business entity, where the emails are provided by, for example, an email application of the one or more enterprise service sources 110. At block 304, the company merger 146 can retrieve historical emails and new emails associated with each stakeholder of the first business entity to generate the client data 128. Further the company merger 146 can be configured to retrieve accounts information from the one or more CRM sources 110 that is indicative of other business entities that the first business entity is associated with (the company merger 146 may additionally be configured to have administrative access to the one or more CRM sources 110). The new emails can be stored in the client data queue 130 such that the historical emails are analyzed by the company merger 146 prior to the new emails and accounts information.

At block 306, the company merger 146 can analyze each email in the historical emails and the new emails to identify an other business entity. More particularly, the company merger 146 is configured to identify email addresses in a header portion of each email and extract signature lines in the each email. Further, the company merger 146 is configured to extract attachments from the each email, and then identify email addresses or signature lines the extracted attachments. For example, the company merger 146 can use the header portion of the email to determine a business entity domain (e.g., website address), etc. Further, the company merger 146 can be configured compare and determine the header portion of the email to the signature line to, for example, confirm information from the header portion, complete missing information from the header portion (e.g., a business entity name, a business entity address, etc.).

At block 308, the company merger 146 is configured to identify an associated business entity in the client data 128 with the identified other business entity based on determined business entity domain or, if available, the business entity name. If the company merger 146 cannot find an associated business entity in the client 128, the company merger 146 is configured to generate and store an indication of the identified other business entity in the client 128. The indication can be generated based on enrichment data received from the one or more enrichment sources 112 (e.g., information retrieved from a website associated with an identified domain name, a business name can be retrieved from a WHOIS server, etc.).

At block 310, the company merger 146 is configured to generate and update, in the client data 128, data associated with the other business entity. More particularly, the company merger 146 is configured to retrieve information from the one or more enrichment sources 112, where the information can include a business name, business website, firmographics, addresses, etc. The company merger 146 can update the client data to include such information. Further, when the other business entity is newly added to the client data 128, the company merger 146 is configured to determine if emails and/or meetings can be associated with the other business entity.

Returning to FIG. 1, the activity merger 148 of the merger component 142 is configured to perform operations similar to the person merger 144 and the company merger 146. In particular, based on emails received from the one or more enterprise services sources 110, the activity merger 148 is configured to identify and extract activities that have or will occur between the first business entity and other business entities based on, for example, information found in the emails (e.g., subject lines), calendar invitations, email attachments, etc. The activity merger 148 can be configured to associated the activities with the first business entity and any associated business entity, as well as participants from the referenced business entities. Further, an activity tracker component 150 of the server continuity component 136 can be configured to determine, based upon the activities, stages of the activities. For example, the activity tracker component 150 can be configured to identify whether an activity as at a beginning stage or complete (e.g., a deal is undergoing negotiations or the deal is about to close).

With more detail regarding the access control component 138, the access control component 138 regulates the end users 116-118 access to subsets of the client data 128 and the GUI presentations generated based on the client data 128 at, for example, the client computing devices 104-106. For example, a first account (e.g., profile for the insight application 126) for an executive of the first business entity could have access to all the client data 128 and GUI presentations, while a second account for lower level associates of the first business entity could be limited to client data 128 (and GUI presentations) associated with particular sales relationships, other business entities, etc. Access of the lower level associates could be further limited by, for example, temporal or geographical limitations. Access of the first account and the second account can be implemented my profile management techniques that are available in the art. The access control component 138 can be configured to execute prior to the merger component 142 such that information is screened prior to being included in the client data 128.

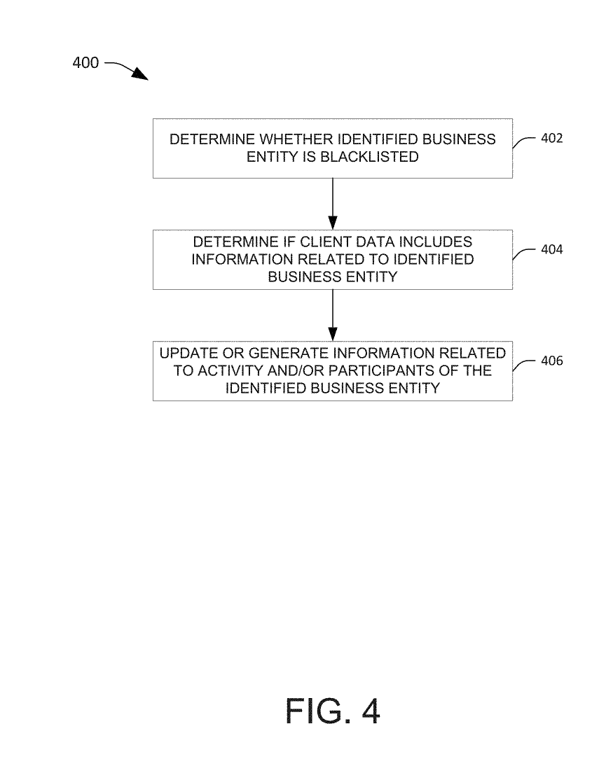

FIG. 4 illustrates an example embodiment of the access control process 400 that can be performed by the access control component 138.

At block 402, the access control component 138 is configured to determine whether data retrieved from the one or more CRM sources 108 or the one or more enterprise services sources 110 is blacklisted from being included in the client data 128. More particularly, the insight application can be configured 126 such that it possess access to certain business entities that associated with a first business entity. For example, a list of business entities that should not be tracked by the insight application 126 can be used by the access control component 138 to determine whether an identified business entity (from the one or more CRM sources 108 or the one or more enterprise services sources 110) is blacklisted.

At block 404, if an identified business entity is not blacklisted, the access control component 138 is configured to determine whether the identified business entity exists in the client data. If the identified business entity does not exist in the client data 128, the access control component 138 can create an indication of the identified business entity in the client data 128.

At block 406, the access control component 138 is configured to update or generate information related to activities and/or participants of the identified business entity in the client data 128. For example, the access control component 138 can be configured to grant permission to the merger component 142 to create or update indications of the identified business entity in the client data 128. Further, at block 406, the access control component 138 can be configured to update records that are indicative of access to specific stakeholders of the first business entity (whose data is stored in the client data 128).

### Example Graphical User Interfaces (GUIs)

The presentation component 140 of the insight application 126 includes a notification component 152 and a GUI engine 154. As will be described below, the notification component 142 and the GUI engine 154 can be configured to transmit data for presentation on the client computing devices 104-106 and/or cause to generate graphical representations on the client computing devices 104-106, where the transmitted data and the graphical representations are indicative of trends or analyses in the client data 128.

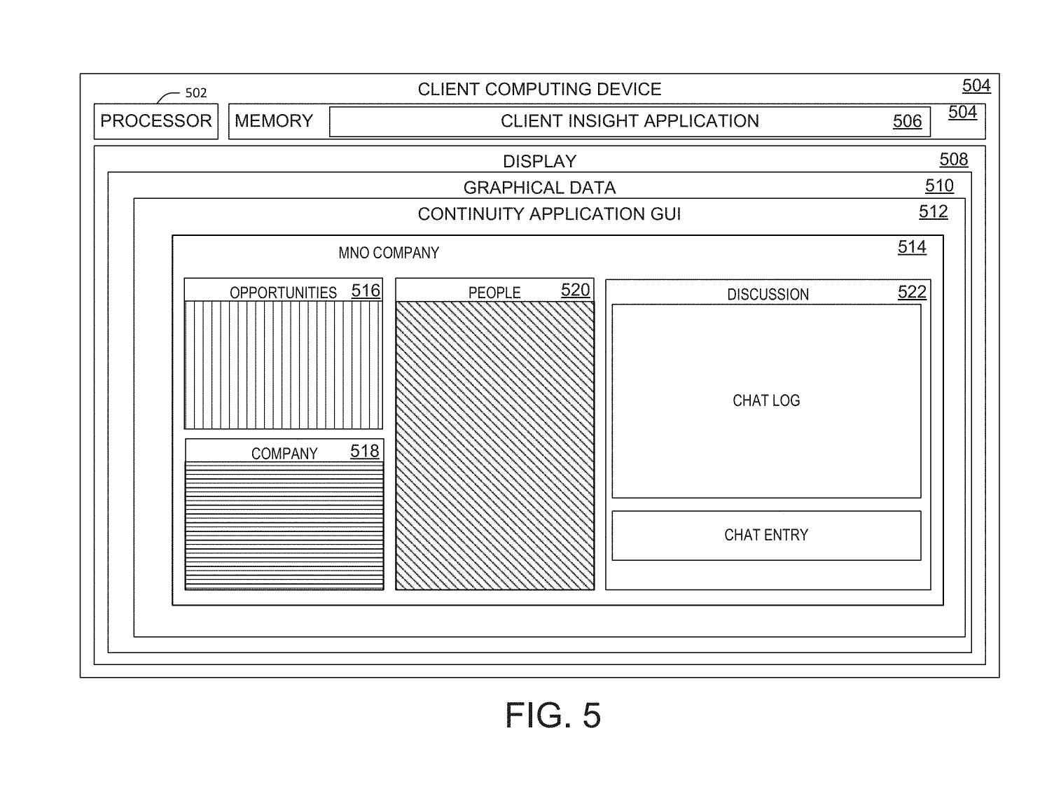

With reference to FIG. 5, a client computing device 104 includes a processor 502 and memory 504. The memory 504 stores instructions that are executed by the processor 502. More specifically, the memory 504 includes a client insight application 506. The client computing device 504 further includes a display 508, which is configured to present graphical data 510 to the one or more end users 116-118. The graphical data 510 may include data presented by way of the client insight application 506. While the display 508 is depicted as being integral to the client computing device 104, it is to be understood that the display 508 may be externally coupled to the client computing device 104 or may be a projected display.

In operation, the one or more end users 116-118 can interact with the client insight application 506 executing on the client computing device 104. This interaction causes the client insight application 506 to transmit data to the insight application 126 executing on the server computing device 102. Content of the data transmitted from the client insight application 506 to the insight application 126 can include, for instance, queries or requests for data that is indicative of the first business entity. The insight application 126 then causes the server computing device 102 to transmit search results to the client computing device 104, whereupon the search results are provided to the client insight application 506. The client insight application 506 subsequently causes at least a portion of the search results to be presented in the graphical data 510 on the display 150 of the client computing device 104, for example, in a continuity application GUI 512.

As shown in FIG. 5, the continuity application GUI 512 can be configured to generate a include a company pane 514 includes data regarding a business entity (e.g., a customer company) that is in a sales relationship with the client business entity that is whose data is stored in the client data 128. The company pane 514 can include an opportunities pane 516, a company information pane 518, a people pane 520, and a discussion pane 522. The opportunities pane 516 can include information regarding on-going deals that have between the business entity and the client business entity, where the information regarding the on-going deals have been generated and stored in the client data 128 based on the processes described herein (e.g., identified in the one or more CRM sources 108 or the one or more enterprise services sources 110). The company information pane 518 can include information regarding the business entity that has been generated and stored in the client data 128 based on the processes described herein. For example, the company information pane 518 can include general contact information that has been verified by the insight application 126 with data from the one or more enrichment sources 112. The people pane 520 can include information indicative of the employees of the business entity that have been in contact with the client business entity, where the information has been generated and stored in the client data 128 based on the processes described herein. The discussion pane 522 can include a chat that is managed by the insight application to enable messaging between the one or more end users 116-118.

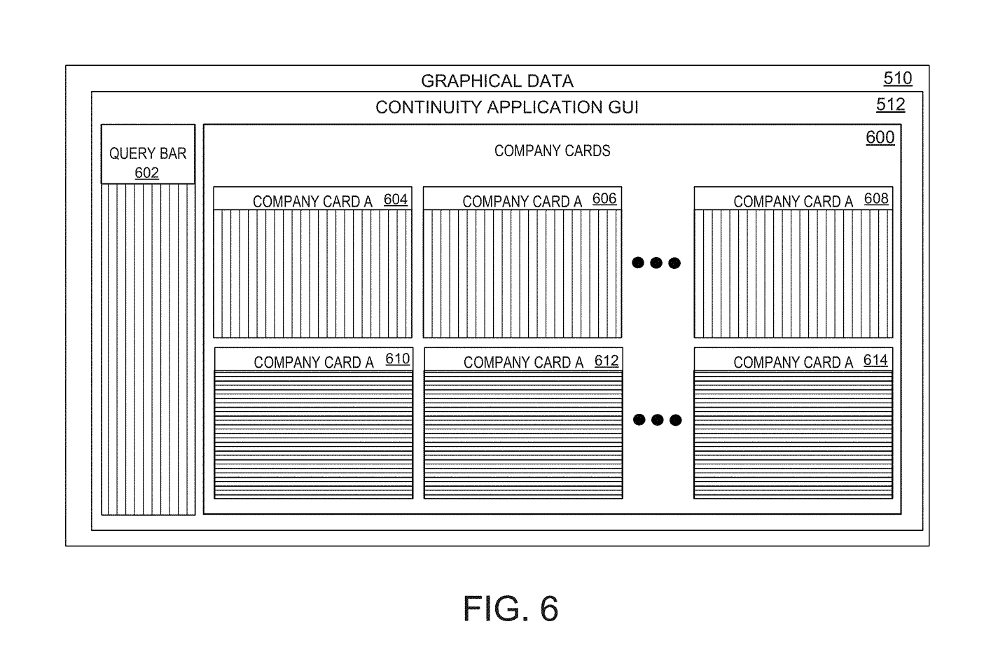

FIGS. 6-14 illustrate example GUIs that can be implemented by some or all of the systems of FIGS. 1, 5, and 16, and/or some or all of the operations described in FIGS. 2-4.

With reference to FIG. 6, the continuity application GUI 512 can be configured to present a company card pane 600 and a query bar 602. The company card pane 600 can include one or more company cards 604-614, where a company card 604 in the one or more company cards 604-614 can contain general information about a business entity that is in a sales relationship with the client business entity (whose data is reflected in the client data 128). The company card 604 can be configured to display, for example, information regarding a most temporally recent transaction (e.g., a deal) between the business entity and the client business entity, including a data of transaction, total cost of the transaction etc. Alternatively, the company card 604 can be configured to, for example, present information regarding identities of contacts that were most frequently contacted by representatives of the client business entity and the business entity (of the company card 604). Access to the company card pane 600 can be can be regulated by the access control component 138 as described herein. The query bar 602 can be configured to receive input by the one or more users 116-118, where the input can be indicative of a search that the one or more users 116-118 would like to perform in the client data 128. The search can be regulated by the access control component 138 as described herein.

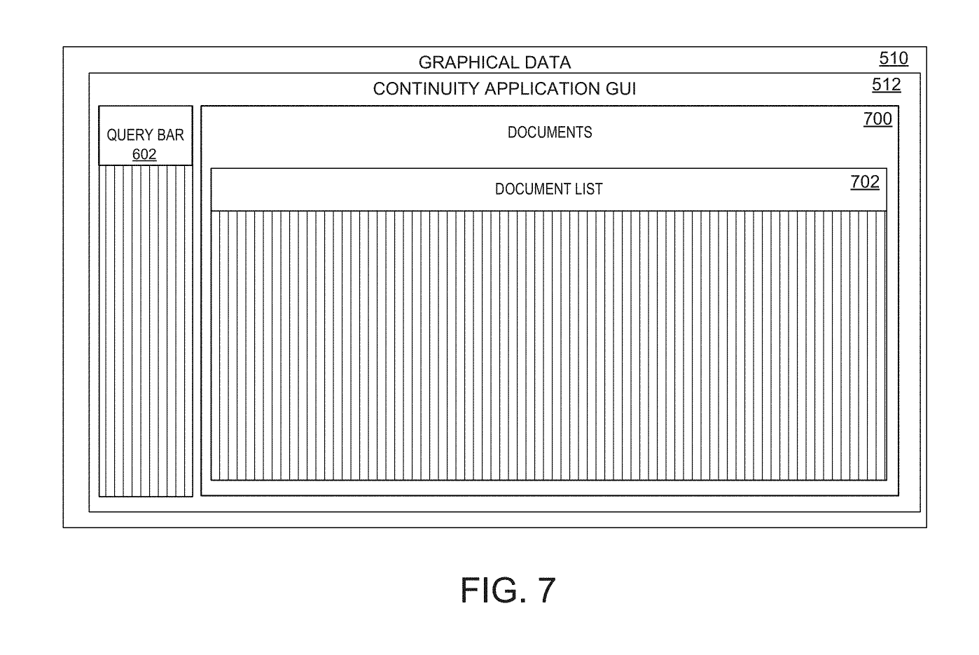

With reference to FIG. 7 the continuity application GUI 512 can be configured to present a documents pane 700 and the query bar 602. The documents pane 700 can include documents that have been stored in the client data 128, where the documents are specific to a particular business entity that the insight application 126 has identified to be in a sales relationship with. In particular, the documents can be stored in the client data 128 based on the processes described herein. A document list 702 can include links to individual documents that the have been stored in the client data, wherein the links are selectable by the one or more users 116-118. Selecting a link in the links would enable a user to access the document. The documents in the document list 702 that are displayed and the documents that are accessible by the one or more users 116-118 can be regulated by the access control component 138 as described herein.

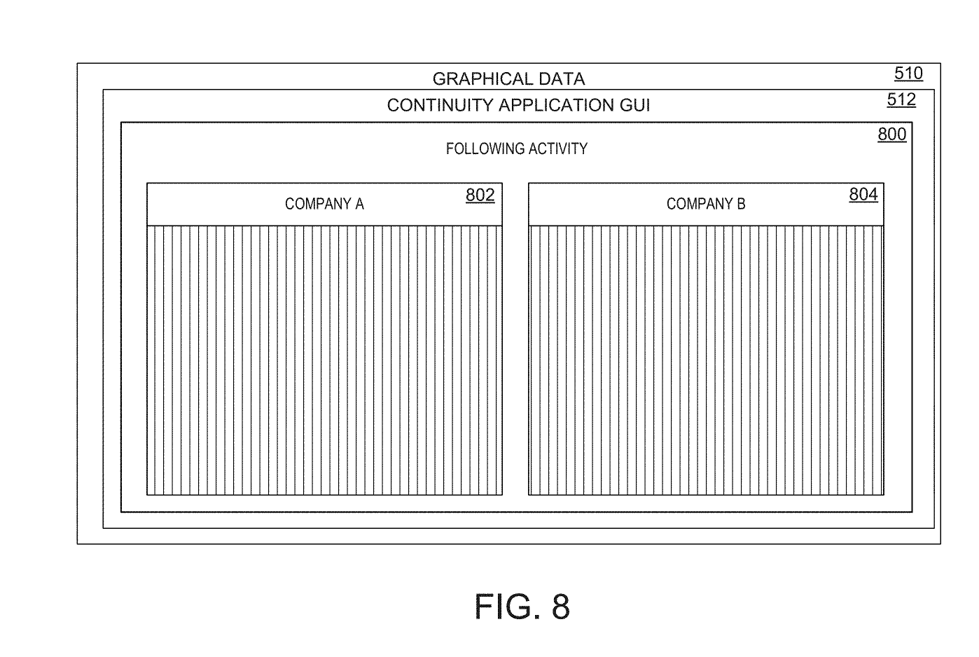

With reference to FIG. 8, the continuity application GUI 512 can be configured to present a following activity pane 800, where the following activity pane 800 includes information regarding sales activity of the client business entity with other business entities. In particular, the following activities pane can include one or more cards 802-804, where a card 802 includes information regarding, for example, a recent exchange of emails between a stakeholder of the client business entity and a stakeholder of the second business entity. The recent exchange of emails can be stored in the client data 128 based on the processes described herein. Further the overall presentation of the one or more cards 802-804 can be sorted and organized based on parameters, for example, temporally, alphabetically by business entity name, etc. Access to the following activity pane 800 can be can be regulated by the access control component 138 as described herein.

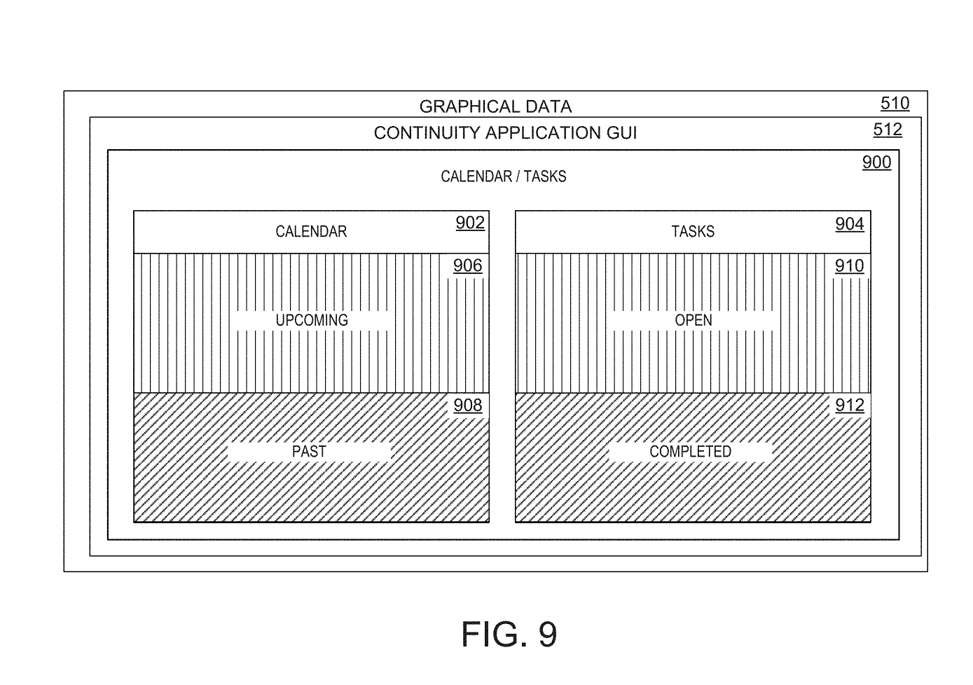

With reference to FIG. 9, the continuity application GUI 512 can be configured to present a calendar and tasks pane 900, where the calendar and tasks pane 900 a calendar pane 902 and a task pane 904. The calendar pane 902 can be configured to include information regarding calendar activity between the client business entity and a business entity that is in a sales relationship with the client business entity, where the calendar activity can be stored in the client data 128 based on the processes described herein. Further, the calendar pane 902 can be configured to separate the presentation of the calendar activity into an upcoming portion 906 and a past portion 908, where activity reflected in these portions is separated based on a data (e.g., a date where the continuity application GUI 512 is generated at a client computing device). The task pane 904 a list of tasks that is managed by the insight application 126 to enable task management between the one or more end users 116-118. Alternatively, the task pane 904 can include tasks that are stored in the client data 128 based on the processes described herein (e.g., based on business data in the one or more enterprise services sources 110). The task pane 904 can include an open portion 910 and a completed portion 912, where the open portion 910 includes tasks that have yet be completed and the completed portion 912 includes tasks that have been completed. Access to the calendar and tasks pane 900 can be can be regulated by the access control component 138 as described herein.

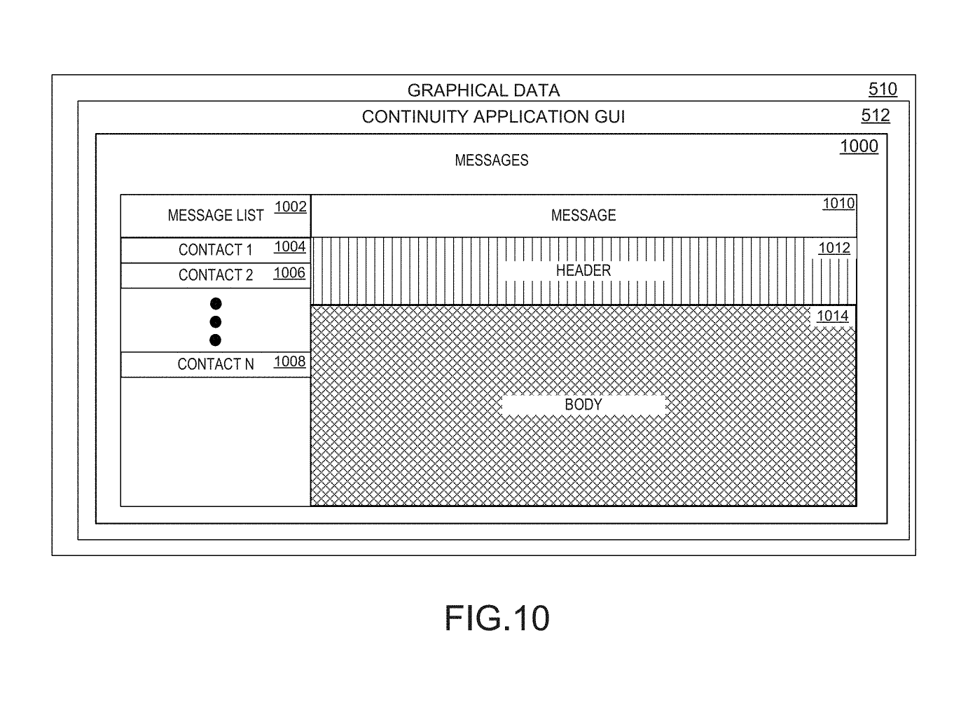

With reference to FIG. 10 the continuity application GUI 512 can be configured to present a messages pane 1000. The messages pane 1000 can include messages that have been stored in the client data 128, where the messages are specific to a particular business entity that the insight application 126 has identified the client business entity to be in a sales relationship with (e.g., emails between stakeholders of the client business entity and stakeholders of the particular business entity). In particular, the messages can be stored in the client data 128 based on the processes described herein. A message list 1002 can include selectable messages 1004-1008, where a selectable message, based on an indication of the one or more end users 116-118, causes the message 1010 to be displayed. The message can include a header 1012 and a body 1014, where the header 1012 includes header information from the selected message and the body 1014 includes body information from the selected message. The selectable messages 1004-1008 in the message list 1002 are displayed and that are accessible by the one or more users 116-118 can be regulated by the access control component 138 as described herein.

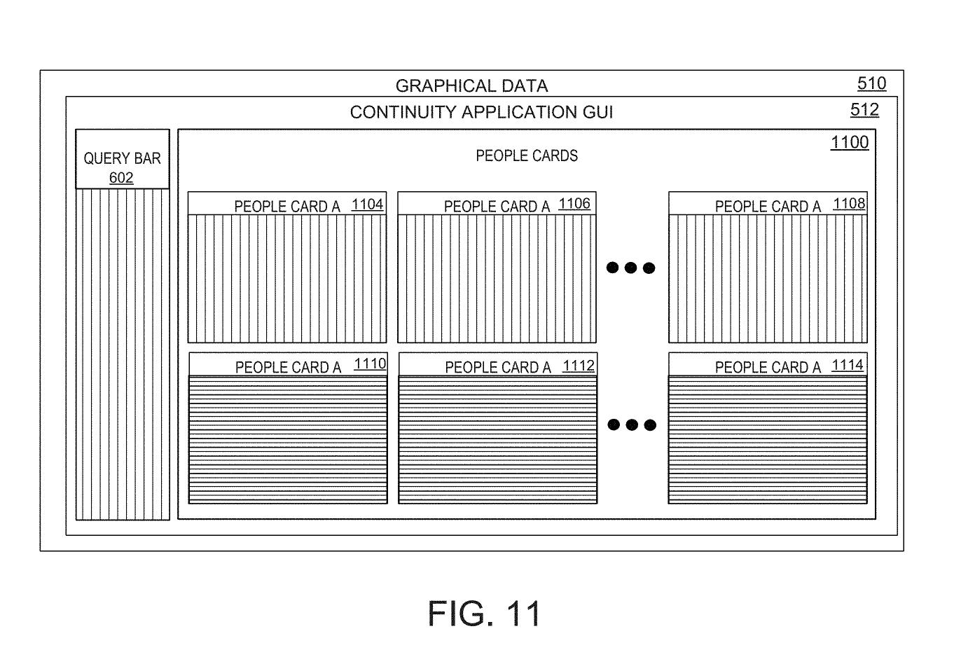

With reference to FIG. 11, the continuity application GUI 512 can be configured to present a people card pane 1100 and the query bar 602. The people card pane 1100 can include one or more people cards 1104-1114, where a people card 1104 in the one or more people cards 1104-1114 can contain general information about a stakeholder of a business entity that is in a sales relationship with the client business entity (whose data is reflected in the client data 128). Data generated with respect to the stakeholder can be stored in the client data 128 based on the processes described herein. The people card 1104 can be configured to display, for example, information regarding a title of the stakeholder, when an email was last sent or receives from the stakeholder, a total number of messages associated with the stakeholder, etc. Access to the people card pane 1100 can be can be regulated by the access control component 138 as described herein.

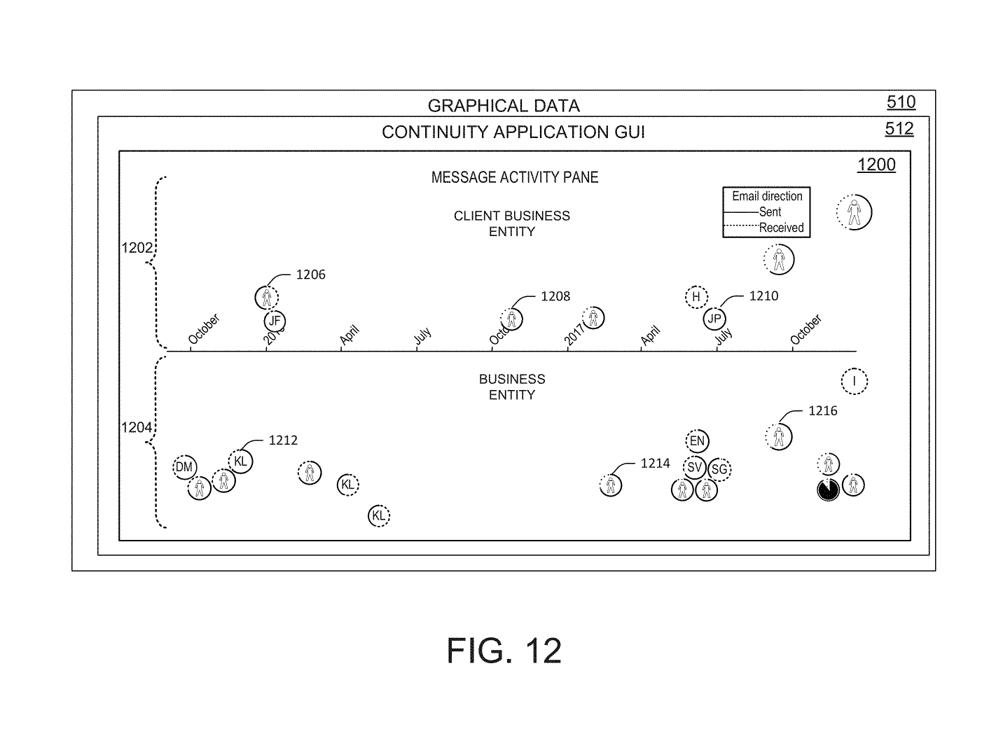

With reference to FIG. 12, the continuity application GUI 512 can be configured to present a message activity pane 1200. The message activity pane 1200 can display a client business entity portion 1202 and a business entity portion 1204 (where the client business entity is in a sales relationship with the business entity). In the client business entity portion 1202, one or more client people indicators 1206-1210 can be shown, where a client people indicator 1206 is indicative of a stakeholder of the client business entity who has been in email contact with a stakeholder of the business entity. The client people indicator 1206, as shown in FIG. 12, can also be configured to reflect, in a graphical representation, a ratio of emails sent by the stakeholder (to the business entity) and emails received by the stakeholder (from the business entity). Further, the one or more client people indicators 1206-1210 can be reflective of messages associated with a stakeholder of the client business entity for a particular month, day, etc. As such, more than one client people indicators may be shown in the client business entity portion 1202 for the stakeholder.

In the business entity portion 1204, one or more sales people indicators 1212-1216 can be shown, where a sales people indicator 1212 is indicative of a stakeholder of the business entity who has been in email contact with a stakeholder of the client business entity. The sales people indicator 1212, as shown in FIG. 12, can also be configured to reflect, in a graphical representation, a ratio of emails sent by the stakeholder (to the client business entity) and emails received by the stakeholder (from the client business entity). Further, the one or more sales people indicators 1212-1216 can be reflective of messages associated with a stakeholder of the business entity for a particular month, day, etc. As such, more than one sales people indicators may be shown in the client business entity portion 1204 for the stakeholder of the business entity. The messages, from which the client business entity portion 1202 and the business entity portion 1204 are generated, can be stored in the client data 128 based on the processes described herein

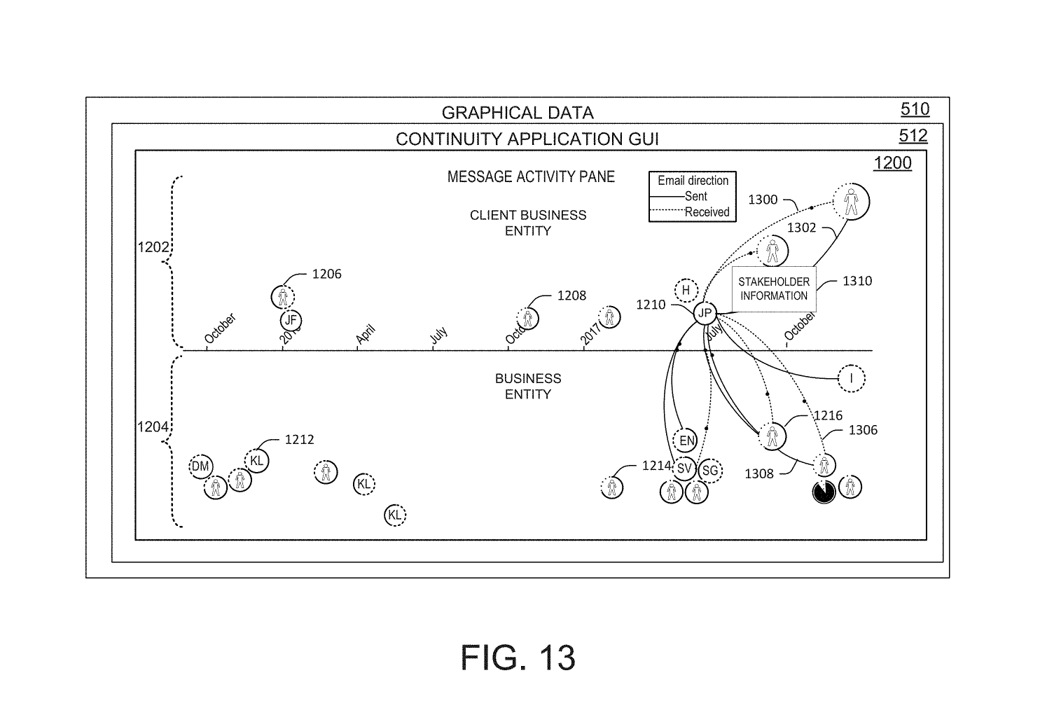

With reference to FIG. 13, an alternative view of the message activity pane 1200 shown. In particular, the message activity pane 1200 can be configured to receive input from the one or more end user 116-118, where in the input can be indicative of a selection of a client people indicator in the one or more client people indicators 1206-1210 or of a sales people indicator in the one or more sales people indicators 1212-1216. As shown in FIG. 13, selection of a client people indicator 1210 can cause one or more graphical representations 1300-1308 to be shown in the message activity pane 1200, where the each graphical representation 1300 in the one or more graphical representations 1300-1308 indicate a direction of emails from the stakeholder indicated by the selected client people indicator 1210. As shown, a first graphical representation 1300 and a second graphical representation 1302 indicate that the stakeholder (represented by the selected client people indicator 1210) has been in email contact with certain stakeholders at the client business entity. Further, a third graphical representation 1306 indicates that the stakeholder has received messages from a certain stakeholder of the business entity (which is in a sales relationship with the client business entity), and a fourth graphical representation 1308 indicates that the stakeholder has sent emails to another certain stakeholder of the business entity.

Further, selection of the client people indicator 1210 can cause a stakeholder information pane 1310 to be displayed. The stakeholder information pane 1310 can include information associated with, for example, a total number of emails sent by the stakeholder (to the business entity), a total number of email received by the stakeholder (from the stakeholder), and a title of the stakeholder. It is to be understood that selection of a sales people indicator in the one or more sales people indicators 1212-1216 would also the stakeholder information pane 1310 to be displayed.

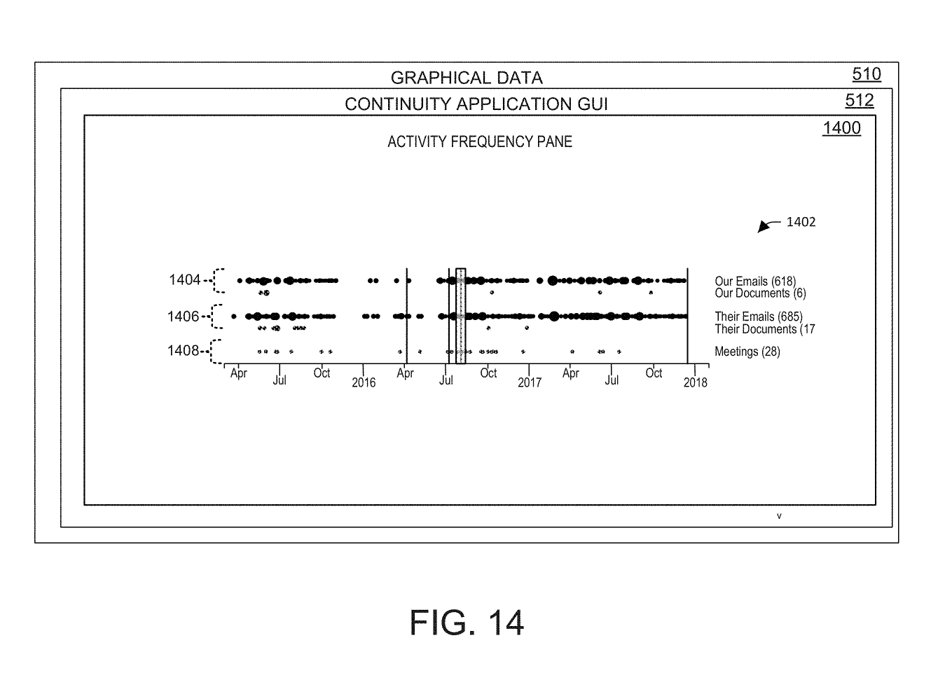

With reference to FIG. 14, the continuity application GUI 512 can be configured to present an activity frequency pane 1400. The activity frequency pane 1400 presents analytics of information between the client business entity and the business entity (that the client business entity is in a sales relationship with), where the information is stored in the client data 128 based on the processes described herein. As shown, a temporal graph 1402 can be shown, where the temporal graph 1402 includes indicators of a frequency of emails, documents, and meetings that between the client business entity and the business entity that the client business entity is in a sales relationship with. In particular, a client business entity portion 1404 can indicate a frequency of emails and documents that are sent by the client business entity (to the business entity). A business entity portion 1406 can indicate a frequency of emails and documents that are sent by the business business entity (to the client business entity). An a meetings portion 1408 can indicate a frequency of meetings that have occurred between the client business entity and the business entity. These portions can be shown along an axis indicative of a range of a months. However, it is to be understood that the axis can be configured to show various ranges of time, including weeks, years, etc.

### Illustrative Methodology

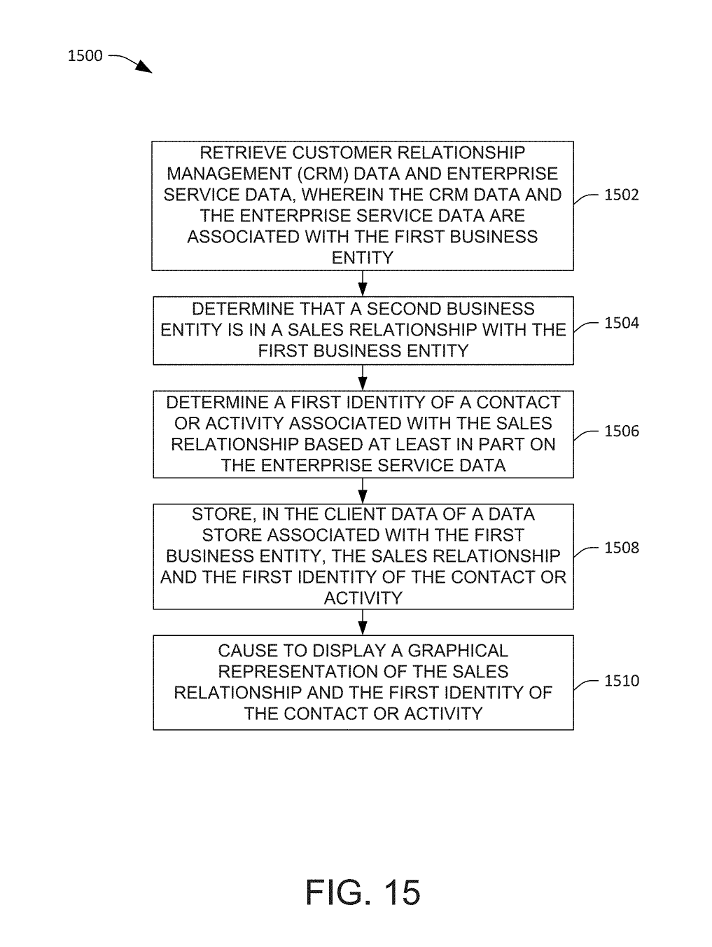

FIG. 15 illustrates a flow diagram of an illustrative methodology 1500 in accordance with one or more example embodiments of the present disclosure.

At block 1502, a device (e.g., the server computing device 102) may retrieve customer relationship management (CRM) data and enterprise service data, wherein the CRM data and the enterprise service data are associated with the first business entity.

At block 1504, the device may determine that a second business entity is in a sales relationship with the first business entity.

At block 1506, the device may determine a first identity of a contact or activity associated with the sales relationship based at least in part on the enterprise service data.

At block 1508, the device may store, in the client data of a data store associated with the first business entity, the sales relationship and the first identity of the contact or activity.

At block 1510, the device may cause to display (e.g., at a client computing device) a graphical representation of the sales relationship and the first identity of the contact or activity in a graphical user interface (GUI).

It is understood that the above descriptions are for purposes of illustration and are not meant to be limiting.

### Computing System

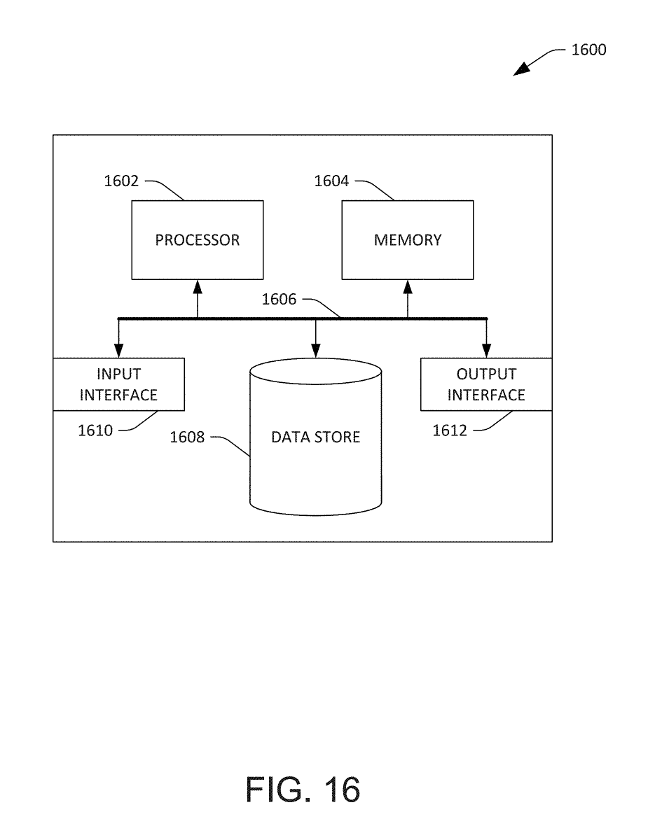

Referring now to FIG. 16, a high-level illustration of an exemplary computing device 1600 that can be used in accordance with the systems and methodologies disclosed herein is illustrated. In some embodiments, a computer such as shown in FIG. 16, and/or a system environment shown in FIG. 1, can implement certain operations and/or may work in conjunction and/or separately from the system shown in FIG. 1 to implement certain operations, for example, as illustrated in the process flows of FIGS. 2-4. For instance, the computing device 1600 may a server computing device 102, a client computing device 104-106, etc. The computing device 1600 includes at least one processor 1602 that executes instructions that are stored in a memory 1604. The instructions may be, for instance, instructions for implementing functionality described as being carried out by one or more components discussed above or instructions for implementing one or more of the methods described above. The processor 1602 may access the memory 1604 by way of a system bus 1606. In addition to storing executable instructions, the memory 1604 can include configuration values, configuration tags, etc.

The computing device 1600 additionally includes a data store 1608 that is accessible by the processor 1602 by way of the system bus 1606. The data store 1608 may include executable instructions, databases, etc. The computing device 1600 also includes an input interface 1610 that allows external devices to communicate with the computing device 1600. For instance, the input interface 1610 may be used to receive instructions from an external computer device, from a user, etc. The computing device 1600 also includes an output interface 1612 that interfaces the computing device 1600 with one or more external devices. For example, the computing device 1600 may display text, GUIs, etc. by way of the output interface 1612.

It is contemplated that the external devices that communicate with the computing device 1600 via the input interface 1610 and the output interface 1612 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1600 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1600 may be a distributed system. Thus, for instance, several devices may be in communication by way of a network connection and may collectively perform tasks described as being performed by the computing device 1600.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

### Conclusion

The systems shown in and described with respect to FIGS. 1 and 5 are provided by way of example only. Numerous other operating environments, system architectures, and device configurations are possible. Other system embodiments can include fewer or greater numbers of components and may incorporate some or all of the functionality described with respect to the system components shown in FIGS. 1 and 5. Accordingly, embodiments of the disclosure should not be construed as being limited to any particular operating environment, system architecture, or device configuration.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed includes not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A computer-implemented method for aggregating client data associated with a first business entity comprising:
retrieving customer relationship management (CRM) data and enterprise service data, wherein the CRM data and the enterprise service data are associated with the first business entity;
determining that a second business entity is in a sales relationship with the first business entity;
determining a first identity of a contact or activity associated with the sales relationship based at least in part on the enterprise service data;
storing, in the client data of a data store associated with the first business entity, the sales relationship and the first identity of the contact or activity; and
causing to display a graphical representation of the sales relationship and the first identity of the contact or activity in a graphical user interface (GUI).

2. The computer-implemented method of claim 1, wherein determining that the second business entity is in the sales relationship with the first business entity comprises:
obtaining administrative access to the CRM data; and
identifying the sales relationship based at least in part on the CRM data.

3. The computer-implemented method of claim 1, wherein determining that the second business entity is in the sales relationship with the first business entity comprises:
obtaining access to the enterprise service data, wherein the enterprise service data comprise one or more email accounts associated with the first business entity;
retrieving an email from the one or more email accounts; and
determining that the second business entity is in the sales relationship with the first business entity based at least in part on a domain name of the second business entity in the retrieved email.

4. The computer-implemented method of claim 3, further comprising retrieving enrichment data that is associated with the second business entity, wherein determining that the second business entity is in the sales relationship with the first business entity based at least in part on the domain name of the second business entity in the retrieved email comprises comparing the enrichment data with the domain name.

5. The computer-implemented method of claim 3, wherein the domain name is located in a sender field or a recipient field of the retrieved email.

6. The computer-implemented method of claim 1, wherein determining the first identity of the contact or activity associated with the sales relationship based at least in part on the enterprise service data comprises:
obtaining access to the enterprise service data, wherein the enterprise service data comprise one or more email accounts associated with the first business entity;
retrieving an email from the one or more email accounts, wherein the email is addressed to an email account of the one or more email accounts; and
determining the first identity of the contact or activity associated with the sales relationship based at least in part on the retrieved email.

7. The computer-implemented method of claim 6, wherein determining the first identity of the contact or activity associated with the sales relationship based at least in part on the retrieved email comprises:
extracting an attachment from the retrieved email; and
identifying the first identity of the contact or activity based at least in part on the attachment.

8. The computer-implemented method of claim 6, wherein determining the first identity of the contact or activity associated with the sales relationship based at least in part on the retrieved email comprises:
identifying the first identity of the contact or activity in in a sender field or a recipient field of the retrieved email; and
comparing the identified first identity of the contact or activity with the CRM data.

9. The computer-implemented method of claim 1, wherein the GUI comprises a message activity pane.

10. The computer-implemented method of claim 1, wherein the GUI comprises an activity frequency pane.

11. A computing device for aggregating client data associated with a first business entity comprising, the computing device comprising storage and processing circuitry configured to:
retrieve customer relationship management (CRM) data and enterprise service data, wherein the CRM data and the enterprise service data are associated with the first business entity;
determine that a second business entity is in a sales relationship with the first business entity;
determine a first identity of a contact or activity associated with the sales relationship based at least in part on the enterprise service data;
store, in the client data of a data store associated with the first business entity, the sales relationship and the first identity of the contact or activity; and
cause to display a graphical representation of the sales relationship and the first identity of the contact or activity in a graphical user interface (GUI).

12. The computing device of claim 11, wherein to determine that the second business entity is in the sales relationship with the first business entity comprises the storage and processing circuitry further configured to:
obtain administrative access to the CRM data; and
identify the sales relationship based at least in part on the CRM data.

13. The computing device of claim 11, wherein to determine that the second business entity is in the sales relationship with the first business entity comprises the storage and processing circuitry further configured to:
obtain access to the enterprise service data, wherein the enterprise service data comprise one or more email accounts associated with the first business entity;
retrieve an email from the one or more email accounts; and
determine that the second business entity is in the sales relationship with the first business entity based at least in part on a domain name of the second business entity in the retrieved email, wherein the domain name is located in a sender field or a recipient field of the retrieved email.

14. The computing device of claim 13, the storage and processing circuitry further configured to retrieve enrichment data that is associated with the second business entity, wherein to determine that the second business entity is in the sales relationship with the first business entity based at least in part on the domain name of the second business entity in the retrieved email comprises the storage and processing circuitry further configured to compare the enrichment data with the domain name.

15. The computing device of claim 11, wherein to determine that the first identity of the contact or activity associated with the sales relationship based at least in part on the enterprise service data comprises the storage and processing circuitry further configured to:
obtain access to the enterprise service data, wherein the enterprise service data comprise one or more email accounts associated with the first business entity;
retrieve an email from the one or more email accounts, wherein the email is addressed to an email account of the one or more email accounts; and
determine the first identity of the contact or activity associated with the sales relationship based at least in part on the retrieved email.

16. The computing device of claim 15, wherein to determine that the first identity of the contact or activity associated with the sales relationship based at least in part on the retrieved email comprises the storage and processing circuitry further configured to:
extract an attachment from the retrieved email, wherein the attachment comprises at least one of: a sales agreement, a term sheet, a calendar invitation, or an electronic profile; and
identify the first identity of the contact or activity based at least in part on the attachment.

17. The computing device of claim 15, wherein to determine that the first identity of the contact or activity associated with the sales relationship based at least in part on the retrieved email comprises the storage and processing circuitry further configured to:
identify the first identity of the contact or activity in in a sender field or a recipient field of the retrieved email; and
compare the identified first identity of the contact or activity with the CRM data.

18. The computing device of claim 11, wherein the GUI comprises a message activity pane.

19. The computing device of claim 11, wherein the GUI comprises an activity frequency pane.

20. A non-transitory computer-readable medium storing computer-executable instructions for aggregating client data associated with a first business entity that, when executed by at least one processor, configure the at least one processor to perform operations comprising:
retrieving customer relationship management (CRM) data and enterprise service data, wherein the CRM data and the enterprise service data are associated with the first business entity;
determining that a second business entity is in a sales relationship with the first business entity;
determining a first identity of a contact or activity associated with the sales relationship based at least in part on the enterprise service data;
storing, in the client data of a data store associated with the first business entity, the sales relationship and the first identity of the contact or activity; and
causing to display a graphical representation of the sales relationship and the first identity of the contact or activity in a graphical user interface (GUI).
